(19) United States
(12) Patent Application Publication
(10) Pub. No.: US 2001/0047673 A1
(43) Pub. Date: Dec. 6, 2001

(54) Locking device

(76) Inventor: Dittmar Schwab, Rodgau (DE)

Correspondence Address: Liniak, Berenato, Longacre & White, Suite 240, 6550 Rock Spring Drive, Bethesda, MD, 20817, US

(21) Appl. No.: 09/825,869

(22) Filed: Apr. 5, 2001

(30) Foreign Application Priority Data
Apr. 8, 2000 (DE) 100 17 559.7

(51) Int. Cl. E05B 13/02

(52) U.S. Cl. 70/423

(57) ABSTRACT

The invention relates to a locking device having a barrel housing (2) which consists of a lower part (3) and a metallic upper part (4) and which surrounds a cylinder housing (5) which consists of metal and in which there is rotatably mounted a cylinder core (6) which can be locked to the cylinder housing (5) via tumblers (7).

In order to enable the locking device (1) to be secure against theft and to still be properly useable even after a prolonged period of non-use, the invention proposes to use a cylinder core (6) made of plastic which is connected in a rotationally fixed manner to a cylinder head (10) made of metal. In this arrangement, the cylinder head (10) has, on its side facing the cylinder core (6), a collar (12) which is arranged in a recess (13) between the upper part (4) and an L-shaped annular collar (14) which bears against the lower part (3) and is part of the cylinder core (6). As a result, when the locking device (1) is fitted on the vehicle door, the cylinder head (10) cannot be removed by an unauthorized third party, and the cylinder core (6), which is connected to the cylinder head (10) and consists of plastic, can neither be pulled out of the cylinder housing (5), nor driven into it by force.

The invention relates to a locking device having a barrel housing which consists of a lower part and a metallic upper part and surrounds a cylinder housing which consists of metal and in which there is a rotatably mounted cylinder core which can be locked to the cylinder housing via tumblers.

A locking device of this type is disclosed, for example, in DE 38 27 418 A1. In this case, the barrel housing, the cylinder housing and the cylinder core with the tumblers usually consist of a metal alloy (zinc diecasting alloy). The known locking device is therefore relatively stable and has good security against theft.

However, it has proven disadvantageous that when the locking device has not been operated for a prolonged period, contact corrosion or dirt or resinified grease cause the parts which bear against one another to become stuck, with the result that the locking device can only be operated with difficulty, if at all, by the corresponding key. The problem therefore arises, particularly in the case of newer vehicles in which the vehicle doors are opened and closed by means of remote control, that in the event of an emergency operation using the key, the locking device is no longer capable of functioning.

Locking devices having a cylinder core made of plastic are already known where the tumblers, which consist of metal, are fitted without grease. However, locking devices of this type are not secure against theft and can easily be broken open by an unauthorized third party. They are therefore predominantly used only for securing glove compartments and petrol-tank caps.

The invention is based on the object of disclosing a locking device which is secure against theft and whose proper use is still ensured even after a prolonged period of non-use, and which is therefore suitable in particular for vehicles whose doors are primarily opened and closed by operation of a remote control.

According to the invention, this object is achieved by the features of claim 1. Further, particularly advantageous refinements of the invention are disclosed by the subclaims.

The invention is essentially based on the concept of using a locking device having a cylinder core which consists of plastic and is connected in a rotationally fixed manner to a cylinder head made of metal. In this arrangement, the cylinder head has, on its side facing the cylinder core, a collar which is arranged in a recess between the housing upper part and an L-shaped annular collar which bears against the lower part of the housing and is part of the cylinder core. As a result, when the locking device is fitted on the vehicle door, the cylinder head cannot be removed by an unauthorized third party and the cylinder core, which is connected to the cylinder head and consists of plastic, can neither be pulled out from the cylinder housing, nor be driven into it by force.

In order to achieve rapid and precise installation of the locking device, it has proven advantageous if the rotationally fixed connection between the cylinder core and the cylinder head takes place by a form-fitting connection, and the axial fixing of the two parts takes place via a clip connection.

In a preferred embodiment of the invention, the axial limb of the L-shaped annular collar of the cylinder core is designed at predetermined intervals on the circumference in the form of bearing cams and in these regions is in each case of a length which is selected in such a manner that an opening in the form of a gap is left between the collar of the cylinder head and the upper part of the barrel housing. This ensures that even via the edge of the cylinder core, contact between the cylinder head and the upper part of the barrel housing is avoided.

Further details and advantages of the invention emerge from the following exemplary embodiments which are explained with reference to figures, in which:

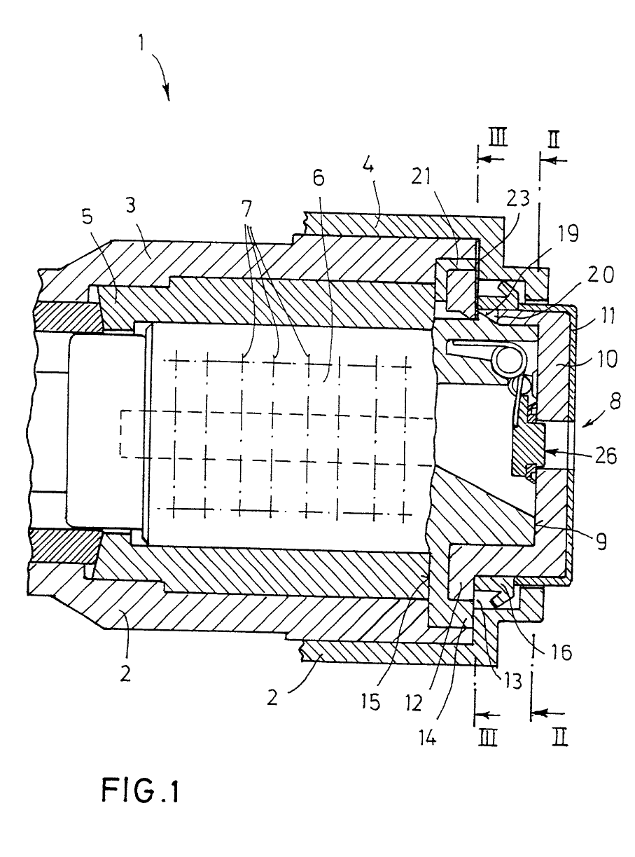

FIG. 1 shows the longitudinal section through part of a locking device according to the invention;

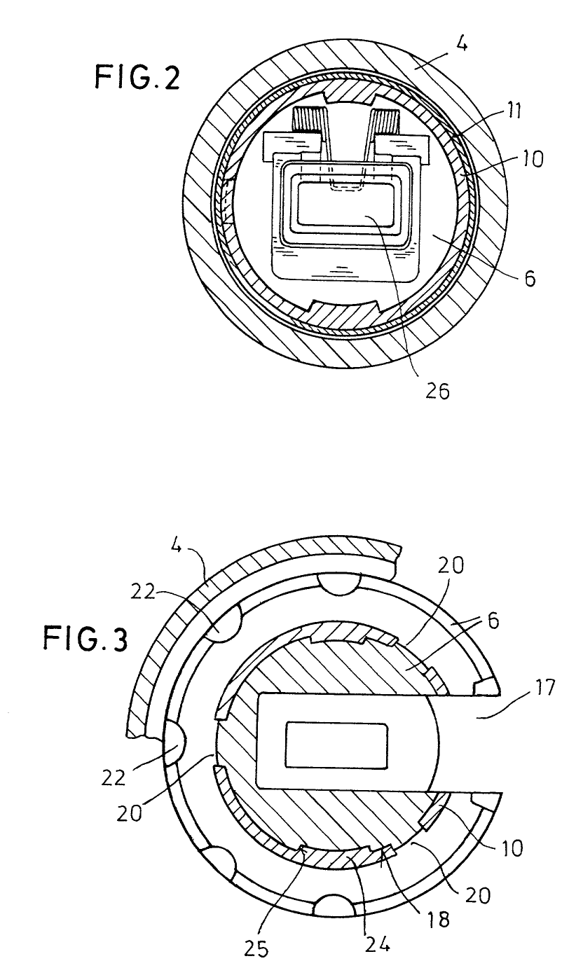

FIG. 2 shows a section along the line denoted by II-II in FIG. 1, and

FIG. 3 shows a section along the line denoted by III-III in FIG. 1.

In FIG. 1, 1 denotes a locking device for a motor-vehicle door (not illustrated). The locking device 1 comprises a barrel housing 2 which consists, for example, of a zinc diecasting and is essentially composed of a cylindrical lower part 3 and an upper part 4 which is arranged above it in a form-fitting manner. The lower and upper parts are connected to one another via a bayonet connection or via pins, for example. Bearing against the inside of the lower part 3 is a cylinder housing 5 which consists of metal and in which there is rotatably mounted a cylinder core 6 which consists of plastic and can be locked to the cylinder housing 5 via tumblers 7 (only indicated schematically).

According to the invention, on the end side 9 which faces the key insertion side 8, a cylinder head 10 which is made of metal (for example, zinc diecasting) is fastened to the cylinder core 6. In addition, for example for aesthetic reasons, a cap 11, for example made of steel or plastic, is arranged on top of the cylinder head 10.

The cylinder head 10 has, on its side facing the cylinder core 6, a collar 12 which is arranged in a recess 13. The recess 13 is formed, on one side, by an encircling annular collar 14 which is of L-shaped design and is part of the cylinder core 6 which is supported on the lower part 3 and on the front end 15 of the cylinder housing 5 and, on the other side, by the upper part 4, with the result that the cylinder head 10 and therefore also the cylinder core 6 are secured against being pulled out.

Also situated in the recess 13 is a sealing ring 16 which is intended to prevent moisture from penetrating into the interior of the locking device 1. Any moisture which in spite of this passes into the interior of the locking device 1 can flow off to the outside via the opening, which is denoted in FIG. 3 by 17.

In order to bring about the axial fixing, the cylinder head 10 and the cylinder core 6 are connected to each other via the clip connection. For this purpose, on the outer circumference 18 of the cylinder core 6 there are situated lug-shaped projections 19 (FIG. 1) which are distributed evenly over the circumference and engage in corresponding recesses 20 of the cylinder head 10 (in order to better illustrate the latching connection, one of the three latching lugs 19 and the associated recess 20 have been reproduced to be fitted into the plane of projection).

In order to bring about the rotationally fixed connection between the cylinder 6 and the cylinder head 10, the cylinder head has two opposite cams 24 which engage in a form-fitting manner in corresponding longitudinal grooves 25 of the cylinder core 6.

In order to prevent contact from taking place between the cylinder head 10 and the upper part 4 of the barrel housing 2, the axial limb 21 of the L-shaped annular collar 14 of the cylinder core 6 is designed at predetermined intervals on the circumference in the form of bearing tines 22 (FIG. 3) and in these regions is in each case of a length which is selected in such a manner that an opening 23 in the form of a gap of, for example 0.1 to 0.2 mm, is left between the collar 12 of the cylinder head 10 and the upper part of the barrel housing 2 (FIG. 1).

On that side of the cylinder core 6 which faces the cylinder head 10 a dust seal 26, which is known per se, is connected to the said cylinder core via a clip connection.

The invention is not, of course, restricted to the above-described exemplary embodiment. Thus, for example, for the connection between the cylinder core and cylinder head, instead of being provided with cams the cylinder head may be provided with an encircling rounded portion which engages in a corresponding recess of the cylinder core.

1. Locking device having a barrel housing (2) which consists of a lower part (3) and a metallic upper part (4) and surrounds a cylinder housing (5) which consists of metal and in which there is rotatably mounted a cylinder core (6) which can be locked to the cylinder housing (5) via tumblers (7), having the following features:
the cylinder core (6) consists of plastic and, in the region of its end side (9) which faces the key insertion side (8), is connected in a rotationally fixed manner to a cylinder head (10) made of metal and the cylinder head (10) has, on its side facing the cylinder core (6), a collar (12) which is arranged in a recess (13) which is formed, on one side, by an encircling annular collar (14) which is of L-shaped design and is part of the cylinder core (6) which is supported on the lower part (3) of the barrel housing (2) and on the front end (15) of the cylinder housing (5) and, on the other side, by the upper part (4) of the band housing (2), with the result that the cylinder head (10) is secured against being pulled out.

2. Locking device according to claim 1, characterized in that in order to bring about the rotationally fixed connection between the cylinder core (6) and the cylinder head (10), the cylinder head (10) has at least one cam (24) or an encircling rounded portion which engages in a form-fitting manner in a corresponding longitudinal groove (25) of the cylinder core (6).

3. Locking device according to claim 1, characterized in that in order to bring about the axial fixing, the cylinder head (10) and the cylinder core (6) are connected to each other via a clip connection.

4. Locking device according to claim 3, characterized in that on the outer circumference (18) of the cylinder core (6) there are provided a plurality of lug-shaped projections (19) which are distributed evenly over the circumference and engage in corresponding recesses (20) of the cylinder head (10).

5. Locking device according to claim 1, characterized in that the cylinder head (10) is a zinc diecasting.

6. Locking device according to claim 5, characterized in that the zinc diecasting (10) is provided with an additional cap (11) made of steel or plastic.

7. Locking device according to claim 1, characterized in that the axial limb (21) of the L-shaped annular collar (14) of the cylinder core (6) is designed at predetermined intervals on the circumference in the form of bearing cams (22) and in these regions is in each case of a length which is selected in such a manner that an opening (23) in the form of a gap is left between the collar (12) of the cylinder head (10) and the upper part (4) of the barrel housing (2).

8. Locking device according to claim 1, characterized in that a dust seal (26) is arranged on that side of the cylinder core (6) which faces the cylinder head (10).

9. Locking device according to claim 1, characterized in that a sealing ring (16) is arranged between the collar (12) of the cylinder head (10) and the upper part (4) of the barrel housing (2).
